(19) United States
(12) Patent Application Publication
(10) Pub. No.: US 2012/0132739 A1
(43) Pub. Date: May 31, 2012

(54) MOVEABLE SHAFT ASSEMBLY

(76) Inventors: Bernard Pusheck, Cudahy, WI (US); Russell Cascio, Brown Deer, WI (US); Justin Zunker, Port Washington, WI (US)

(21) Appl. No.: 13/307,072

(22) Filed: Nov. 30, 2011

Related U.S. Application Data
(60) Provisional application No. 61/458,709, filed on Nov. 30, 2010.

(51) Int. Cl. B02C 19/00; F16C 3/02

(52) U.S. Cl. 241/220; 464/179

(57) ABSTRACT

A moveable shaft assembly including a frame, a first shaft, and a first drive assembly. The frame includes a first support wall and a second support wall opposite the first support wall. The first shaft includes a drive end and a support end and defining a first axis therebetween. The first shaft extends between the first support wall and the second support wall. The first drive assembly rotates the first shaft about the first axis, and the first drive assembly is coupled to the drive end of the first shaft. The first shaft and first drive assembly are moveable relative to the frame in response to a reaction force acting on the first shaft in a direction oblique or transverse to the first axis.

### BACKGROUND

The present invention relates to the field of mining machines, and particularly to a roll sizer for breaking apart and crushing mined material.

Conventional mining roll sizers include a pair of parallel counter-rotating roll assemblies positioned within a crushing chamber. The shafts include a series of picks arranged along the surface. As the roll assemblies rotate, the picks engage material that is fed into the crushing chamber, breaking the material apart until it is small enough to pass around the rolls. During normal operation, it is possible for the chamber to receive a tramp material, which is a very hard, dense material. The picks are unable to break apart the tramp material and pass it through the crushing chamber, causing the rolls to bind and one or more picks to break. This requires the roll sizer to be shut down so that the tramp can be removed and any necessary repairs be made to the roll assemblies.

### SUMMARY

In one embodiment, the invention provides a moveable shaft assembly includes a frame, a first shaft, and a first drive assembly. The frame includes a first support wall and a second support wall opposite the first support wall. The first shaft includes a drive end and a support end and defines a first axis therebetween. The first shaft extends between the first support wall and the second support wall. The first drive assembly rotates the first shaft about the first axis, and the first drive assembly is coupled to the drive end of the first shaft. The first shaft and first drive assembly are moveable relative to the frame in response to a reaction force acting on the first shaft in a direction oblique or transverse to the first axis.

In another embodiment, the invention provides a roll sizer for a mining crusher, the roll sizer including a frame, a first mobile shaft support, a second mobile shaft support, a first shaft, and at least one actuator. The frame includes a first support wall and a second support wall. The first support wall includes a first shaft track, and the second support wall includes a second shaft track parallel to the first shaft track. The first mobile shaft support moveably engages the first shaft track. The second mobile shaft support moveably engages the second shaft track. The first shaft includes a drive end and a support end and defines a first axis therebetween. The drive end is coupled to a first gear drive for rotating the first shaft about the first axis. The first shaft extends from the first support wall to the second support wall, and is rotatably supported by the first mobile shaft support and the second mobile shaft support. The at least one actuator applies a force to move the first and second mobile shaft supports along the first and second shaft support tracks, respectively. The first drive assembly moves in a direction parallel to the mobile shaft supports while coupled to the first shaft.

In yet another embodiment, the invention provides a method for adjusting a shaft spacing in a roll sizer. The method includes: providing a first shaft defining a first axis and a second shaft defining a second axis parallel to the first axis, the first shaft being rotatable about the first axis; providing a drive assembly coupled to the first shaft for rotating the first shaft; sensing the forces acting on the first shaft; and operating an actuator to provide a force to move the first shaft from a position that is a first distance from the second shaft to a position that is a second distance from the second shaft, the second distance being greater than the first distance, wherein the drive assembly moves with the first shaft.

Other aspects of the invention will become apparent by consideration of the detailed description and accompanying drawings.

### BRIEF DESCRIPTION OF THE DRAWINGS

FIG. 1 is a perspective view of the roll sizer according to one embodiment of the invention.

FIG. 2 is a top view of the roll sizer of FIG. 1 wherein a first roll assembly is positioned proximate a second roll assembly.

FIG. 3 is a top view of the roll sizer of FIG. 1 wherein the first roll assembly is positioned away from the second roll assembly.

FIG. 4 is an enlarged perspective view of the roll sizer of FIG. 1 with the first drive assembly removed.

FIG. 5 is a section view of a portion of the roll sizer of FIG. 1 taken along line 5-5.

FIG. 6 is a side view of a first carriage, a first drive assembly, and a torque arm.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof Unless specified or limited otherwise, the terms “mounted,” “connected,” “supported,” and “coupled” and variations thereof are used broadly and encompass both direct and indirect mountings, connections, supports, and couplings.

Although the invention is described below as it relates to a roll sizer, it is important to note that the invention is also applicable to conveyors having a moveable shaft or other devices having a drive shaft that is moveable in response to a force.

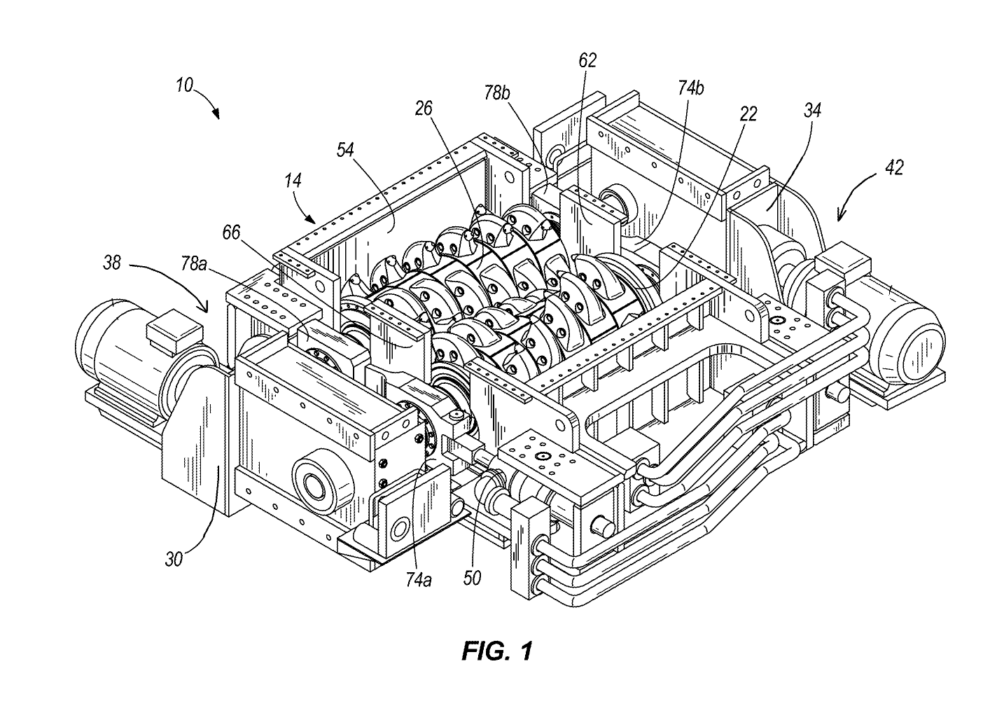

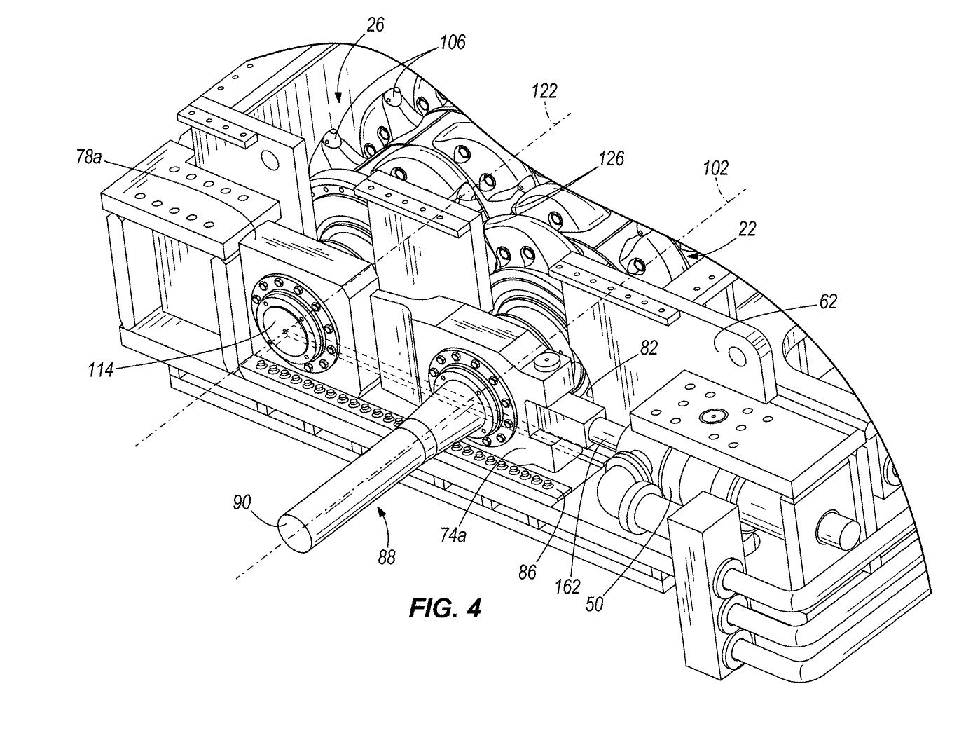

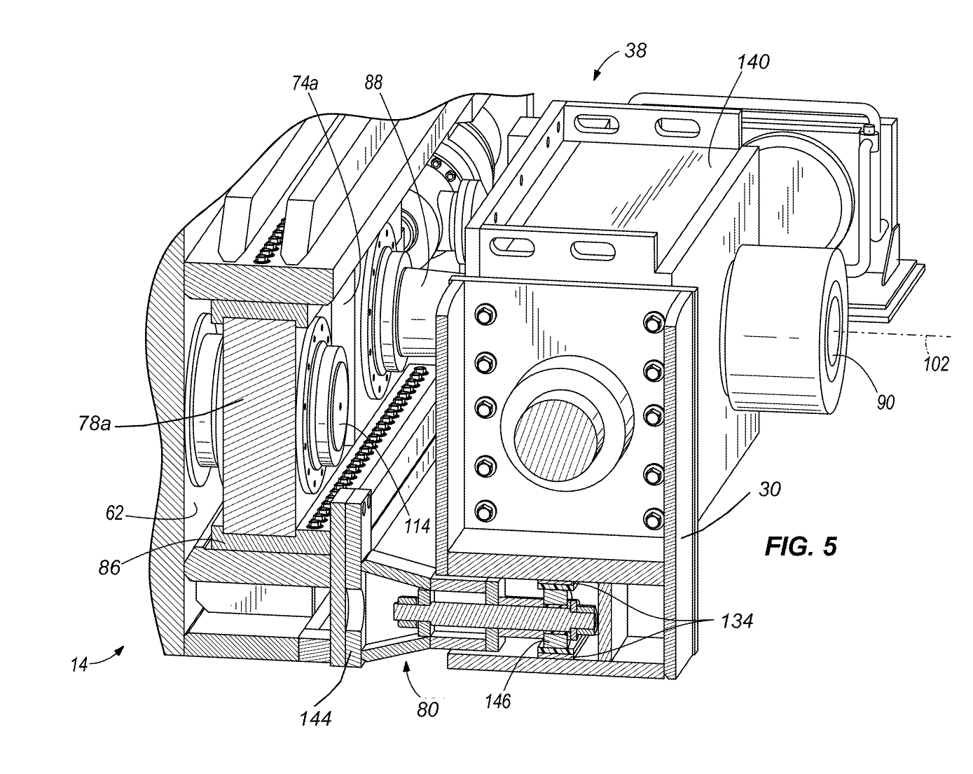

FIG. 1 illustrates a mining roll sizer 10. The roll sizer 10 includes a frame 14, a first roll assembly 22, a second roll assembly 26, a first carriage 30, a second carriage 34, a first drive assembly 38 supported by the first carriage 30, a second drive assembly 42 supported in the second carriage 34, and an actuator 50. The frame 14 defines an interior chamber 54. In one embodiment the interior chamber 54 has a rectangular shape. The frame 14 includes a first support wall 62, a second support wall 66 mounted opposite the first support wall 62, a pair of mobile shaft supports 74a, 74b for rotatably supporting the first roll assembly 22, a pair of stationary shaft supports 78a, 78b for rotatably supporting the second roll assembly 26, and a torque arm 80 (FIG. 5). The first support wall 62 and the second support wall 66 each include an elongated slot 82 (FIG. 4) extending through each respective support wall 62 and 66. The first support wall 62 and the second support wall 66 each include a track 86 (FIG. 4) positioned adjacent the slot 82. Each of the mobile shaft supports 74a, 74b moveably engages one of the tracks 86. In the illustrated embodiment, the mobile shaft supports 74a, 74b slidably engage the tracks 86. In other embodiments, the mobile shaft supports 74a, 74b may move in another manner, such as rolling with respect to the tracks 86. The torque arm 80 is discussed in further detail below.

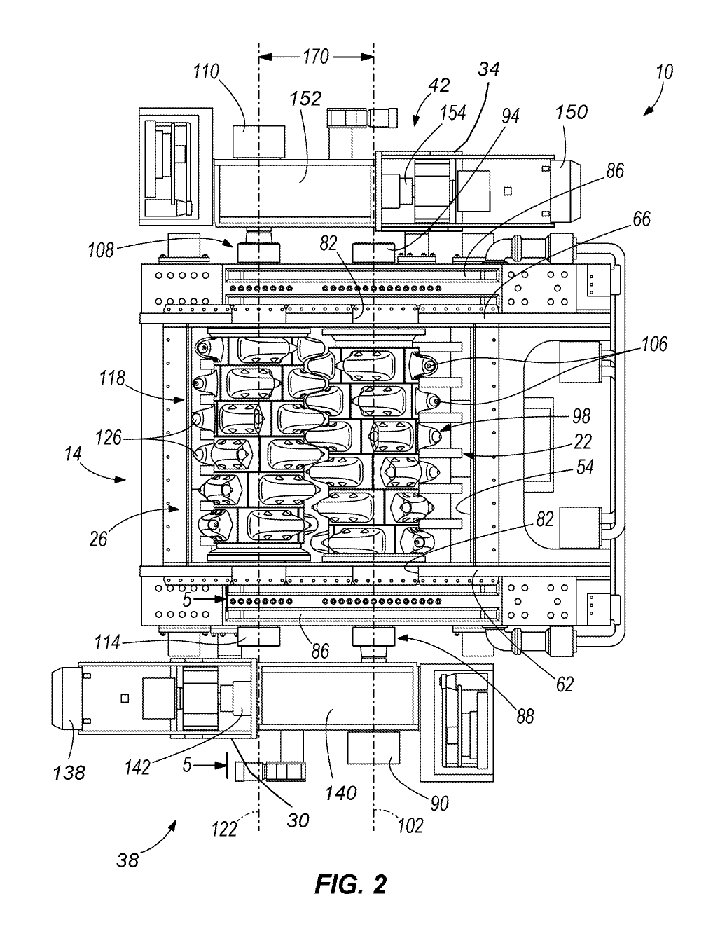

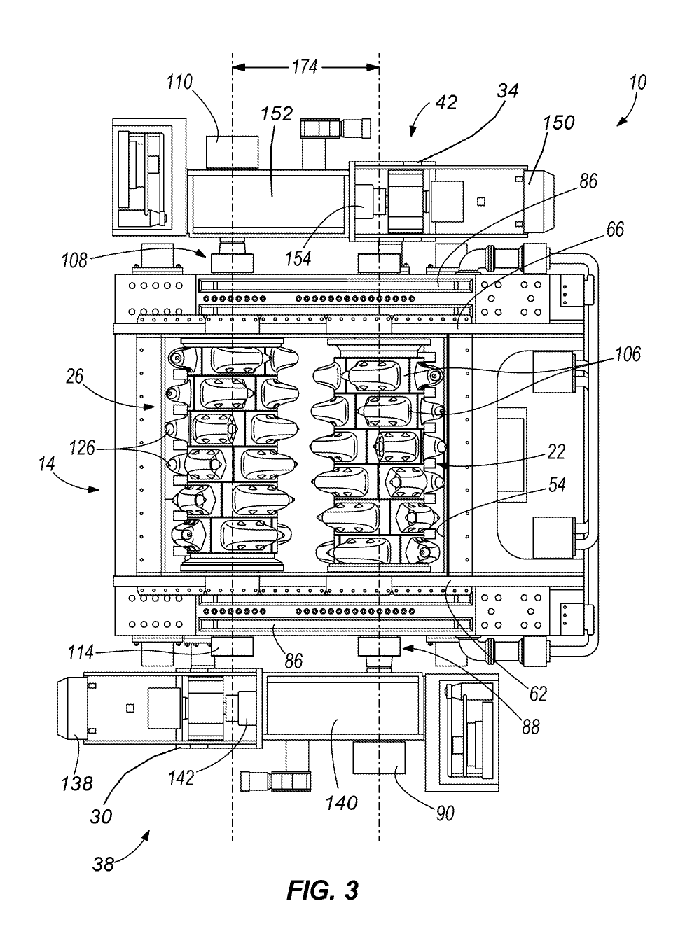

As shown in FIGS. 2 and 3, the first roll assembly 22 is positioned substantially within the interior chamber 54 and includes a first shaft 88 having a drive end 90 and a support end 94 opposite the drive end 90. The first roll assembly 22 also includes a crushing portion 98 coupled to the first shaft 88. The first shaft 88 defines a first axis 102 between the drive end 90 and the support end 94. The drive end 90 extends through the slot 82 in the first support wall 62 and is coupled to the first drive assembly 38 for rotating the first roll assembly 22. The drive end 90 is rotatably supported by a first mobile shaft support 74a. The support end 94 extends through the slot 82 of the second support wall 66 and is rotatably supported by a second mobile shaft support 74b. In one embodiment, the mobile shaft supports 74a, 74b include a tapered roller bearing for rotatably supporting the first shaft 88. In other embodiments, another type of bearing may be used. The crushing portion 98 is located within the interior chamber 54 and includes multiple picks 106 that are oriented to point in the direction of rotation of the first shaft 22.

The second roll assembly 26 is positioned substantially within the interior chamber 54 and parallel to the first shaft 88. The second roll assembly 26 includes a second shaft 108 having a drive end 110 and a support end 114 opposite the drive end 110. The second roll assembly 26 also includes a crushing portion 118 coupled to the second shaft 108. The second shaft 108 defines a second axis 122 between the drive end 110 and the support end 114. The drive end 110 extends through the second support wall 66 and is coupled to the second drive assembly 42 for rotating the second roll assembly 26. The drive end 110 is rotatably supported by a second stationary shaft support 78b. The support end 114 extends through the first support wall 66 and is rotatably supported by a first stationary shaft support 78a. In one embodiment, the stationary shaft supports 78a, 78b include a tapered roller bearing for rotatably supporting the second shaft 108. In other embodiments, another type of bearing may be used. The crushing portion 118 is located within the interior chamber 54 and includes multiple picks 126 that are oriented to point in the direction of rotation of the second shaft 26.

The first roll assembly 22 and the second roll assembly 26 are counter-rotating, such that the first roll assembly 22 and the second roll assembly 26 rotate in opposite directions when viewed from a common side. Stated differently, the roll assemblies 22, 26 rotate in opposite directions so that the picks 126 rotate over the top of each roll assembly 22, 26. In the embodiment illustrated in FIG. 3, as viewed along each axis 102, 122 from the first support wall 62, the first roll assembly 22 rotates in a counter-clockwise direction and the second roll assembly 26 rotates in a clockwise direction. As the first roll assembly 22 and the second roll assembly 26 rotate, the picks 106 of the first roll assembly 22 pass between the picks 126 of the second roll assembly 26 without contacting one another. In other embodiments, the roll assemblies 22, 26 may be configured to rotate in another manner.

As shown in FIGS. 2 and 5, the first carriage 30 is positioned proximate the first support wall 62 and supports the first drive assembly 38. The first carriage 30 includes a torque arm track 134 (FIG. 5). The first drive assembly 38 includes a first motor 138, a first gear drive 140, and a first torque limiter 142. The first gear drive 140 receives the drive end 90 of the first shaft 88. The first torque limiter 142 (FIG. 2) removably couples the first motor 138 to the first gear drive 140, maintaining a mechanical connection to transmit power from the first motor 138 to the first shaft 88. If a maximum allowable torque is reached, the torque limiter 142 uncouples the first motor 138 and the first gear drive 130 and permits the first motor 138 to rotate freely. As used herein with respect to a torque limiter, the term “uncouple” and variants thereof generally refer to disconnecting a motor and a gear drive to interrupt the transmission of power from the motor to the gear drive. This includes the slipping of friction discs in a torque limiter.

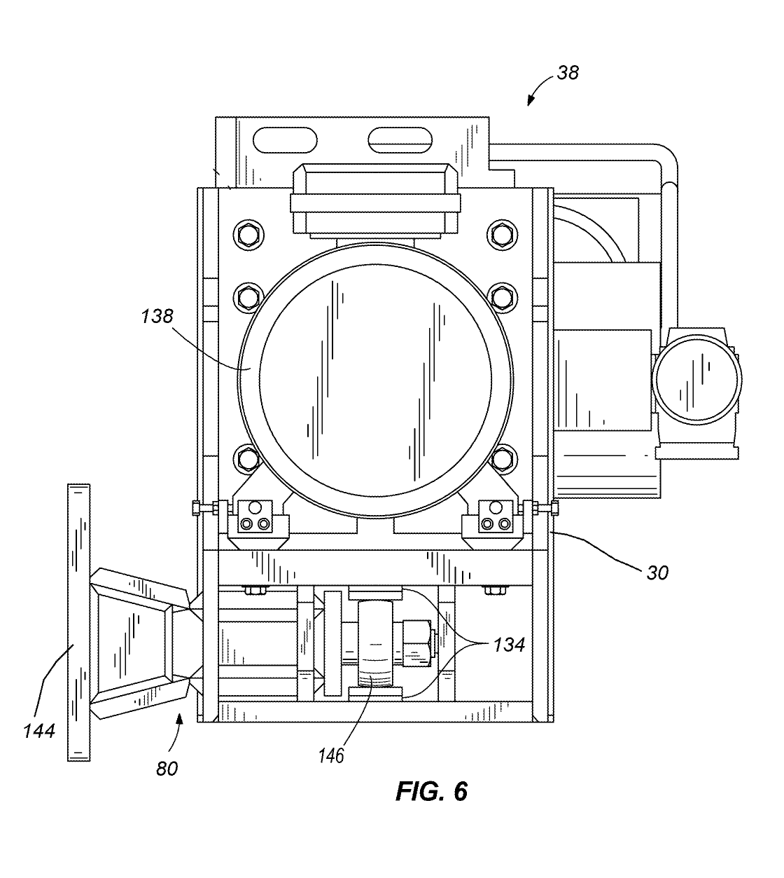

As illustrated in FIGS. 5 and 6, the torque arm 80 includes a first end 144 coupled to the frame 14 and a second end 146 that moveably engages the torque arm track 134. The torque arm 80 supports the first carriage 30 for movement with respect to the support wall 66 and secures the first carriage 30 against rotation about the first shaft 88. In the illustrated embodiment, the second end 146 rolls with respect to the torque arm track 134. In other embodiments, the second end 146 may move in another manner, such as sliding with respect to the torque arm track 134. In other embodiments, the torque arm track 134 may be coupled to the frame 14 and the torque arm 80 may be coupled to the first carriage 30.

Referring to FIG. 2, the second carriage 34 is positioned proximate the second support wall 66 and supports the second drive assembly 42. In the illustrated embodiment, the second carriage 34 is coupled to the frame 14. The second drive assembly 42 includes a second motor 150, a second gear drive 152, and a second torque limiter 154. The second gear drive 152 receives the drive end 110 of the second shaft 108. The second torque limiter 154 removably couples the second motor 150 to the second gear drive 152, maintaining a mechanical coupling to transmit power from the second motor 150 to the second shaft 108. If a maximum allowable torque is reached, the torque limiter 154 uncouples the second motor 150 and the second gear drive 152 and permits the second motor 150 to rotate freely.

As shown in FIGS. 1 and 4, the actuator 50 includes a pair of extendible hydraulic rams 162 positioned adjacent the mobile shaft supports 74a, 74b in a direction parallel to the track 86 (only the ram 162 adjacent the first mobile shaft support 74a is shown in FIGS. 1 and 4; a similar ram is positioned adjacent the second mobile shaft support 74b). Pressure in the ram 162 is maintained by a valve (not shown) and is monitored with a pressure sensor (not shown). When the pressure applied on the ram 162 from the contact with the mobile shaft support 74a exceeds a given value, the valve is opened and hydraulic fluid is forced out of the ram 162, causing the ram 162 to retract. The rams 162 are coupled to the mobile shaft supports 74a such that operation of the rams 162 applies a force to the mobile shaft support 74a and moves the mobile shaft support 74a along the track 86. The actuator 50 may be configured to either push or pull the shaft support 74a.

In other embodiments, when the rams 162 are extended, the rams 162 contact the mobile shaft supports 74a, 74b to prevent the mobile shaft supports 74a, 74b from moving along the track 86. When the pressure applied on each ram 162 from the contact with the mobile shaft supports 74a, 74b exceeds a given value, the valve is opened and the pressure on the ram 162 is decreased, causing the ram 162 to retract and allowing the mobile shaft supports 74a, 74b to move along the track 86.

During operation of the roll sizer 10, the interior chamber 54 receives material from, for example, a conveyor (not shown). Pieces of the material are urged toward a position between the rotating roll assemblies 22 and 26 where the force of the picks 106, 126 converge, breaking apart the pieces to a desirable size. When a hard material, or tramp, is introduced into the interior chamber 54, the tramp material resists the breaking force of the picks 106, 124. This creates reaction forces on each roll assembly 22, 26, acting in a direction that is either oblique or transverse to each axis 102, 122. As used herein, the term “oblique” refers to a direction that is neither parallel nor perpendicular to either axis 102, 122. As used herein, the term “transverse” refers to a direction that is perpendicular to either axis 102, 122. The reaction forces press the mobile shaft supports 74a, 74b against the hydraulic rams 162, increasing the hydraulic pressure acting against the ram 162. The pressure sensor detects the pressure increase, and sends an electrical signal to a controller to open the valve and reduce pressure on the ram 162. This allows the rams 162 to retract, allowing the tramp material to pass through the roll assemblies 22, 26. In an alternative embodiment (not shown), the valve may open only by influence of the hydraulic pressure, without the use of an electric sensor.

As shown in FIG. 4, the retraction of the rams 162 permits the mobile shaft supports 74a, 74b (and therefore the first roll assembly 22) to move along the track 86 in a direction perpendicular to the first axis 102. The first roll assembly 22 moves from a position spaced apart from the second roll assembly 26 by a first distance 170 (FIG. 2) to a position that is spaced apart from the second roll assembly 26 by a second distance 174 that is greater than the first distance 170. The first shaft 88 moves within the slot 82 (FIG. 3) in the first support wall 62, causing the first carriage 30 to move with respect to the frame 14 in a direction parallel to the track 86. The first carriage 30 is supported throughout this motion by the second end 146 of the torque arm 80 (FIGS. 5 and 6), which moves along the torque arm track 134 (FIGS. 5 and 6).

In this manner, the first roll assembly 22 moves away from the second roll assembly 26 in a direction parallel to the track 86, increasing the space between the first roll assembly 22 and the second roll assembly 26. This allows the tramp material to pass through the interior chamber 54 without damaging the roll assemblies 22, 26. In one embodiment, the first shaft 88 travels in a first direction parallel to the track 86 through a distance of approximately 12 inches, and travels in a second direction opposite the first direction through a distance of approximately 4 inches. In one embodiment, the first distance 170 is approximately 62 inches, with alternative shaft supports that allow the operator to configure the first distance 170 to be approximately 64 inches, 66 inches, or 68 inches.

Thus, the invention provides, among other things, a moveable shaft assembly for a roll sizer. Various features and advantages of the invention are set forth in the following claims.

What is claimed is:

1. A moveable shaft assembly comprising:
a frame including a first support wall and a second support wall opposite the first support wall;
a first shaft including a drive end and a support end and defining a first axis therebetween, the first shaft extending between the first support wall and the second support wall; and
a first drive assembly for rotating the first shaft about the first axis, the first drive assembly being coupled to the drive end of the first shaft,
wherein the first shaft and first drive assembly are moveable relative to the frame in response to a reaction force acting on the first shaft in a direction oblique or transverse to the first axis.

2. The moveable shaft assembly of claim 1, further comprising an actuator for applying a force to move the first shaft and first drive assembly in response to the reaction force.

3. The moveable shaft assembly of claim 1, further comprising a second shaft defining a second axis, the second shaft being rotated about the second axis, the second shaft extending between the first support wall and the second support wall, wherein the second axis is spaced a first distance from the first axis, and wherein the first shaft is moveable to a position spaced a second distance from the second axis, the second distance being greater than the first distance.

4. The moveable shaft assembly of claim 3, wherein the second axis is parallel to the first axis such that the first axis and the second axis define a sizer plane, wherein the first shaft moves in a direction parallel to the sizer plane.

5. The moveable shaft assembly of claim 4, the frame including a track positioned adjacent each support wall.

6. The moveable shaft assembly of claim 5, further comprising a pair of mobile shaft supports for rotatably supporting the first shaft, each mobile shaft support moveably engaging one of the tracks, wherein movement of the first shaft is caused by movement of the mobile shaft supports along the tracks.

7. The moveable shaft assembly of claim 6, further comprising at least one hydraulic actuator that moves the mobile shaft supports along the tracks when the reaction force exerted on a portion of the first shaft located between the first support wall and the second support wall exceeds a predetermined value.

8. The moveable shaft assembly of claim 3, wherein the first shaft and the second shaft are counter-rotating such that the first shaft rotates in a first direction about the first axis and the second shaft rotates in a second direction about the second axis, the second direction being opposite the first direction when viewed along both axes.

9. The moveable shaft assembly of claim 1, wherein as the first shaft and the first drive assembly move relative to the frame, the first shaft and the first drive assembly remain coupled such that the first drive assembly can rotate the first shaft.

10. The moveable shaft assembly of claim 1, further comprising a carriage supporting the first drive assembly for movement with the first shaft.

11. The moveable shaft assembly of claim 10, further comprising a torque arm track coupled to one of the frame and the carriage, and a torque arm including a first end and a second end, the first end being coupled to the other of the frame and the carriage, the second end moveably engaging the torque arm track to resist rotation of the carriage about the first shaft.

12. The moveable shaft assembly of claim 1, wherein the first drive assembly includes a motor, a gear drive coupled to the drive end of the first shaft, and a first torque limiter for removably coupling the motor and the gear drive such that when a torque on the first shaft exceeds a predetermined level, the first torque limiter uncouples the gear drive from the motor so that the motor rotates freely.

13. A roll sizer for a mining crusher, the roll sizer comprising
a frame including a first support wall and a second support wall, the first support wall including a first shaft track, the second support wall including a second shaft track parallel to the first shaft track;
a first mobile shaft support moveably engaging the first shaft track;
a second mobile shaft support moveably engaging the second shaft track;
a first shaft including a drive end and a support end and defining a first axis therebetween, the drive end being coupled to a first gear drive for rotating the first shaft about the first axis, the first shaft extending from the first support wall to the second support wall, the first shaft being rotatably supported by the first mobile shaft support and the second mobile shaft support; and
at least one actuator for applying a force to move the first and second mobile shaft supports along the first and second shaft support tracks, respectively, wherein the first drive assembly moves with the mobile shaft supports while coupled to the first shaft.

14. The roll sizer of claim 13, further comprising a second shaft defining a second axis parallel to the first axis, the second shaft being coupled to a second drive assembly for rotating the second shaft.

15. The roll sizer of claim 14, the first shaft further including at least one pick located between the first support wall and the second support wall, the second shaft further including at least one pick located between the first support wall and the second support wall.

16. The roll sizer of claim 14, the first shaft and the second shaft being arranged in a counter-rotating manner.

17. The roll sizer of claim 15, further comprising a carriage supporting the first drive assembly, the first drive assembly including a motor, a gear drive coupled to the drive end of the first shaft, and a first torque limiter for removably coupling the motor and the gear drive such that, when a torque on the first shaft exceeds a predetermined level, the first torque limiter uncouples the gear drive from the motor so that the motor rotates freely.

18. The roll sizer of claim 17, further comprising a torque arm track coupled to one of the frame and the carriage, and a torque arm including a first end and a second end, the first end being coupled to the other of the frame and the carriage, the second end moveably engaging the torque arm track to resist rotation of the carriage about the first shaft.

19. A method for adjusting a shaft spacing in a roll sizer, the method comprising:
providing a first shaft defining a first axis and a second shaft defining a second axis parallel to the first axis, the first shaft being rotatable about the first axis;
providing a drive assembly coupled to the first shaft for rotating the first shaft;
sensing the forces acting on the first shaft; and
operating an actuator to provide a force to move the first shaft from a position that is a first distance from the second shaft to a position that is a second distance from the second shaft, the second distance being greater than the first distance, wherein the drive assembly moves with the first shaft.

20. The method of claim 19, further comprising providing a frame defining an interior chamber, at least a portion of the first shaft and the second shaft being positioned within the interior chamber; and passing material into the interior chamber such that the material is crushed as it passes between the first shaft and the second shaft.

21. The method of claim 20, wherein sensing the forces occurs while the material passes between the first shaft and the second shaft.

22. The method of claim 19, wherein operating the actuator includes maintaining a coupled connection between the first shaft and the drive assembly.

23. The method of claim 19, wherein operating the actuator causes the drive assembly to move in a manner parallel to the movement of the first shaft.

24. The method of claim 19, further comprising securing the drive assembly against rotation about the first shaft.

25. The method of claim 19, wherein the first drive assembly includes a motor, a gear drive coupled to the first shaft, and a first torque limiter for removably coupling the motor and the gear drive.

26. The method of claim 25, further comprising uncoupling the gear drive from the motor when a torque on the first shaft exceeds a predetermined level, such that the motor rotates freely.

27. The method of claim 19, wherein operating the actuator includes relaxing the actuator to permit the first roll assembly to move.
